(19) United States
(12) Patent Application Publication
(10) Pub. No.: US 2004/0086802 A1
(43) Pub. Date: May 6, 2004

(54) Two-dimensional materials and methods for ultra-high density data storage and retrieval

(76) Inventor: Gary A. Gibson, Palo Alto, CA (US)

Correspondence Address: HEWLETT-PACKARD COMPANY, Intellectual Property Administration, P.O. Box 272400, Fort Collins, CO, 80527-2400, US

(21) Appl. No.: 10/286,010

(22) Filed: Oct. 31, 2002

(51) Int. Cl. G11B 7/24

(52) U.S. Cl. 430/270.13; 369/275.2; 428/64.5; 430/945; 369/288

(57) ABSTRACT

An ultra-high density data storage and retrieval unit has a phase-change layer for storing and retrieving data and at least one other layer. The phase-change layer and/or the other layer comprises a two-dimensional material, primarily one of the chalcogen-based materials. The data storage and retrieval unit may have a structure selected from a group consisting of the following configurations:

2-D film/2-D substrate

2-D film/non-2-D substrate

non-2-D film/2-D substrate

2-D film/2-D film/X

2-D film/non-2-D film/X

non-2-D film/2-D film/X

wherein (1) the 2-D film and 2-D substrates are mostly chalcogen-based 15 materials, (2) the 2-D film, 2-D substrate, non-2-D film and non-2-D substrate are a semiconductor, metal, or insulator, and (3) the term X is a subst rate or film made of a material that is (a) 2-D or non-2-D and (b) metal, semiconductor or insulator. The data storage and retrieval unit may be included as a part of a photodiode, cathododiode, phototransistor, cathodotransistor, photoconductor, cathodoconductor, photoluminescent device, and/or cathodoluminescent device.

### FIELD OF THE INVENTION

The present invention relates to ultra-high density data recording and detecting systems using thin films some of which are composed of phase-change materials. More particularly the present invention concerns ultra-high density data recording and detection systems and methods using two-dimensional materials, such as chalcogenide-based materials having van der Waals bonding between adjacent layers.

### BACKGROUND OF THE INVENTION

Electronic devices, such as palm computers, digital cameras and cellular telephones, are becoming more compact and miniature, even as they incorporate more sophisticated data processing and storage circuitry. Moreover, types of digital communication other than text are becoming much more common, such as video, audio and graphics, requiring massive amounts of data to convey the complex information inherent therein. These developments have created an enormous demand for new storage technologies that are capable of handling more complex data at a lower cost and in a much more compact package.

One response to this demand has been the development of ultra-high density storage devices, such as the one described in U.S. Pat. No. 5,557,596 granted to Gibson et al. on Sep. 17, 1996 (“Gibson 596 Patent”). This system provides for a plurality of electron emitters generating beams of electrons to information storage media areas on a movable platform to store and retrieve information. A micro mover, based on micro electro mechanical systems (MEMS) technology moves the platform relative to the electron emitters to enable parallel communications with selected storage media areas on the platform. In the Gibson 596 Patent, the data storage medium consists of a diode whose top layer is a “phase-change” material that can be reversibly changed between crystalline and amorphous states (or between two crystalline states with different electrical properties). Data is written by using an electron beam to locally affect a change of state in the phase-change layer. Bits are detected by interrogating a bit with an electron beam while monitoring the current or voltage induced across the diode. This induced current or voltage will depend upon the local state of the phase-change layer in the interrogated region.

There is a continued need for increased miniaturization and expanded ability to handle greater quantities of more complex data at a faster speed and in even more compact areas. Efforts are now underway to enable the storage of data on a scale of ten nanometers (100 angstroms) up to hundreds of nanometers, referred to herein as “ultra-high density data storage.”

Several challenges arise in attempting to store data at this level. The processes of information storage and retrieval become increasingly difficult tasks. Reading and writing data in extremely compact and miniature areas with electron and/or light beams presents several limitations. Another major concern is finding reliable and effective materials that have the desired phase-change characteristics, including the ability to exhibit contrasts in certain characteristics between phases.

An important aspect that relates to an important aspect of the present invention concerns the need to develop materials that will provide effective means of sensing the contrasts in characteristics of the phase-change materials, so as to determine the data stored therein. As used herein, the term “materials” includes all kinds and types of compounds, alloys and other combinations of elements. In different embodiments of the present invention, two-dimensional materials (defined below) are used in a number of different types of ultra-high density data storage and retrieval systems.

Various forms of data storage and retrieval devices have been developed, including photodiodes and cathododiodes, phototransistors and cathodotransistors, photoconductive and cathodoconductive devices, photoluminescent and cathodoluminescent devices, as well as combinations and variations thereof. See the following co-pending applications: application Ser. No. 09/726,621 filed Dec. 1, 2000, entitled “AFM Version of Diode- and Cathodoconductivity- and Cathodoluminescence-Based Data Storage Media;” application Ser. No. 09/783,008, filed Feb. 15, 2001, entitled “Methods For Conducting Current Between a Scanned-Probe and Storage Medium;” application Ser. No. 10/231,044, filed Aug. 30, 2002, entitled “Luminescence-Based Storage Device;” HP Docket Number 100111365, entitled “Storage Device Based on Phase-Change Modulated Luminescence;” application Ser. No. 09/865,940, filed May 25, 2001, entitled “Data Storage Medium Utilizing Near-Field Optical Source; and application Ser. No. 10/000,404, filed Oct. 31, 2001, entitled “Layer Adjacent the Storage Layer;” application Ser. No. 09/984,419, filed Oct. 30, 2001, entitled “Current Divider-based Storage Medium;” HP Docket No. 1002-00034, entitled “Re-recordable Data Storage Medium With Intermediate Layer and Top Electrode Partially Spanning Phase-changeable Layer;” HP Docket No. 1001-11365, entitled “Conduction Barrier Layer For Re-recordable Data Storage Medium;” application Ser. No. 09/652,777, filed Aug. 30, 2000, now U.S. Pat. No. 6,473,388 granted on Oct. 29, 2002, entitled “Ultra-high Density Information Storage Device Based on Modulated Cathodoconductivity.”

In addition, various types of junctions have been formed in conjunction with one or more of the above devices, such as heterojunctions, homojunctions, and Schottky junctions, in order to achieve the desired detection results. In heterojunctions, two dissimilar semiconductors are used on opposite sides of the junction. A homojunction is formed by using p and n doped versions of the same semiconductor. In general, two slabs or films of the same bulk semiconductor, with different levels or types of dopants that produce different semiconductor parameters in the two slabs or films, are joined at an interface. In Schottky junctions, a semiconductor is joined at an interface with a metal. In some embodiments of the ultra-high density storage devices, a phase-change semiconductor layer forms a Schottky junction with a metal layer. In other embodiments of the ultra-high density storage devices, a phase-change layer forms a heterojunction or homojunction with another semiconductor. Problems encountered with the data detection devices mentioned above include:

Poor diode interfaces (high interface recombination rates, band offsets, trapping sites, band-bending, Fermi level pinning, etc).

Poor semiconductor surfaces (high surface recombination rates, surface band-bending, traps, Fermi level pinning, etc.)

Poor film morphology (topographically rough surfaces, small or uneven grain size, misorientation of grains). This can lead to poor electrical properties and to inhomogeneaties that lead to media noise.

Grain boundaries that interfere with relevant electronic properties (grain boundary scattering, grain boundary recombination, band-bending, Fermi level pinning, grain boundary defects that cause carrier trapping, etc.)

Defects within grains or at surfaces or grain boundaries that adversely impact electrical transport properties of the semiconductors, such as carrier lifetime, carrier mobility, or carrier concentration, that are important to the functioning of the storage medium.

Defects within grains or at surfaces or grain boundaries that interfere with attempts to dope the semiconductors

Limited choice of substrate materials (particularly in the case where a heterojunction is formed directly on a semiconductor substrate) on which to build the device.

### SUMMARY OF THE INVENTION

In the current invention, two-dimensional layered materials are utilized in data storage and retrieval systems to provide relatively clean interfaces and surfaces for the detection of data. These materials can also provide greater spatial uniformity, especially when grown epitaxially, and can grow with fewer of the problematic electrical and optical defects that previously plagued the ultrahigh density data storage devices discussed here. Two-dimensional materials according to the present invention are primarily semiconductors, but can also be metals, such as in Schottky barriers, insulators used in buffering layers, or luminescent layers used in luminescent ultrahigh density storage devices. In cases where these two-dimensional materials are used as phase-change layers, they involve primarily, but not completely, chalcogen-based materials.

These two-dimensional layered materials include the following class of materials, referred to hereinafter as “the included class of two-dimensional (or 2-D) materials”:

the III-VI compounds InTe, InSe, GaSe, GaS, and the hexagonal (metastable) form of GaTe,

the IV-VI compounds GeS, GeSe, SnS, SnSe, SnS₂, SnSe₂, and SnSe₂₋ₓSₓ,

the metal dichalcogenides SnS₂, SnSe₂, WS₂, WSe₂, MoS₂, and MoSe₂,

the transition metal chalcogenides TiS₂, TiS₃, ZrS₂, ZrS₃, ZrSe₂, ZrSe₃, HfS₂, HfS₃, HfSe₂, and HfSe₃,

certain modifications, e.g. certain crystalline structures, of Ga₂S₃, Ga₂Se₃, Ga₂Te₃, In₂S₃, In₂Se₃, In₂Te₃, GeS₂, GeAs₂, and Fe₃S₄,

and all ternary materials having a 2-D layer structure, including ternary chalcogenides having a 2-D layer structure, such as ZnIn₂S₄ and MnIn₂Se₄.

Accordingly, one embodiment of the present invention is an ultra-high density data storage and retrieval unit having a data layer for storing and retrieving data and another layer, wherein the data layer and/or the other layer comprises a two-dimensional material.

Another embodiment of the present invention comprises an ultra-high density data storage and retrieval unit having multiple layers including a phase-change layer for storing and retrieving data. The data storage and retrieval unit has a structure selected from a group consisting of the following configurations:

2-D film/2-D substrate

2-D film/non-2-D substrate

non-2-D film/2-D substrate

2-D film/2-D film/X

2-D film/non-2-D film/X

non-2-D film/2-D film/X

wherein (1) the 2-D film and 2-D substrates are mostly chalcogen-based materials when used in phase-change layers, (2) the 2-D film, 2-D substrate, non-2-D film and non-2-D substrate are a semiconductor, metal, or insulator, and (3) the term “X” is a substrate or film made of a material that is (a) 2-D or non-2-D and (b) metal, semiconductor or insulator. In most cases the films in these structures are epitaxial, but in some cases some of the benefits of the 2-D materials can be realized even in structures where they are polycrystalline and non-epitaxial.

Another embodiment of the present invention comprises a method for forming an ultra-high density data storage and retrieval device comprising forming a data layer for storing and/or retrieving data, forming another layer adjacent to the data layer, wherein the data layer and/or the other layer comprises a two-dimensional material.

As will be demonstrated and discussed hereinafter, the two-dimensional materials that are used in the present invention provide for a number of potential advantages over materials used in similar prior data storage devices, including:

better surfaces (due to fewer dangling bonds and other defects that can cause unwanted recombination, band-bending, etc.)

better interfaces

better/fewer grain boundaries

ability to eliminate or ease doping requirements (e.g. can choose one naturally p-type and one naturally n-type layered chalcogenide)

ability to make doping easier (by eliminating compensating defects, grain boundaries, etc.)

better structural uniformity and better uniformity of electrical properties and, therefore, less media noise

growth compatibility with a variety of substrates, including insulators and metals

overall better film quality (e.g. fewer defects, better electrical and optical properties)

By way of further explanation, it should be understood that, in many polycrystalline, 3-D phase-change materials, doping does not appreciably change the carrier concentration. There are various reasons for this, such as the dopants are not activated (they do not go to the right lattice sites) or there are too many compensating defects, that is, defects that nullify the carriers generated by the dopants. With 2-D materials, it is possible to avoid the necessity of doping by selecting one material that is naturally p-type and another that is naturally n-type. Proper selection of materials minimizes or eliminates any need to alter their carrier concentrations or change the sign of the carrier type. Thus, doping requirements are substantially eased or eliminated. On the other hand, in cases where it is still desirable to dope one of the materials, the 2-D materials can be easier to dope if they contain fewer compensating defects due to dangling bonds, grain boundaries, and so forth.

Another advantage of using two-dimensional materials is that heterojunctions will be between materials that have similar crystal structures, similar constituent atoms, similar electronic properties, and so forth. Thus, 2-D heterojunctions will have many improved characteristics, such as better interfaces, fewer problems with interdiffusion and better electrical properties, than heterojunctions formed from completely different materials, one of which is naturally n-type and the other naturally p-type

Moreover, even polycrystalline 2-D films have potential advantages over polycrystalline non-2-D materials, and devices that include polycrystalline 2-D films have potential advantages over devices that do not include polycrystalline 2-D films. These advantages occur because the nature of the bonding, the grain boundaries, free surfaces, and interfaces in 2-D materials can be more benign in terms of their impact on electrical properties such as carrier lifetime, trapping, mobility, luminescence, and so forth, and, in some cases, because of the relative ease with which the 2-D material can be doped. Furthermore, similarities between the material properties of 2-D materials can lead to advantages when they are combined into a device, even when the 2-D materials are polycrystalline (e.g. a diode formed between polycrystalline InSe and polycrystalline GaSe can have improved electrical properties due to the similarities between these materials).

### BRIEF DESCRIPTION OF THE DRAWINGS

FIG. 1 is a schematic side view of an embodiment of a data storage device utilizing materials according to the present invention and having a secondary emission detection device;

FIG. 2 is a schematic side view of an embodiment of a data storage device utilizing materials according to the present invention and having a semiconductor diode detection device;

FIG. 3 is a schematic side view of an embodiment of a data storage device utilizing materials according to the present invention and having a cathodotransistor/phototransistor detection device;

FIG. 4 is a schematic side view of an embodiment of a data storage device utilizing materials according to the present invention and having a cathodoconductivity/photoconductivity detection device;

FIG. 5 is a schematic side view of an embodiment of a data storage device utilizing materials according to the present invention and having a luminescent layer detection device;

FIG. 6 is a schematic side view of an embodiment of a data storage device utilizing materials according to the present invention and having a detection device with a luminescent layer over a layer of phase-change material acting as a variable-state filter in proximity with a photodetective device;

FIGS. 7A-7D are schematic views comparing conventional epitaxy to van der Waals epitaxy and quasi-van der Waals epitaxy with respect to embodiments of the present invention;

FIG. 8 is a schematic view showing the structure of GaSe-InSe layers with van der Waals forces, according to an embodiment of the present invention;

FIGS. 9A-9C are schematic side views showing various layer configurations of 2-D materials, non-2-D films and substrates according to the present invention;

FIG. 10 is a schematic side view showing one embodiment of the invention using the configurations shown in FIGS. 9A-9C;

FIG. 11 is a schematic side view showing another embodiment of the invention using the configurations shown in FIGS. 9A-9C; and

FIG. 12 is an electron microscope scan of a diode showing an embodiment of the present invention.

### DETAILED DESCRIPTION OF EMBODIMENTS OF THE INVENTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

In many cases, problems with data storage and detection are caused by lattice mismatches between the materials used to form the junctions for the device. These mismatches can lead to strain that results in poor film growth, defects, grain boundary problems, and so forth. Lattice mismatch problems can be particularly acute when the bonding between atoms in these materials is via strong covalent or ionic bonds.

In other cases, the above problems can result, in part, from dangling or frustrated covalent or ionic bonding sites at surfaces or interfaces. For example, dangling or frustrated bonds can lead to trapping, recombination, and other problems at surfaces and interfaces.

It is often desirable to dope the phase-change semiconductors used in these media not only in the homojunction case (where it is necessary), but also in the heterojunction and Schottky diode cases when the carrier density and/or resistivity of the phase-change material need to be adjusted. However, many of the phase-change materials used in prior solutions are difficult to dope. In some cases, this difficulty is the result of defects at surfaces, grain boundaries or within grains that compensate intentional doping attempts. Again, these defects can result from the mismatch of lattice parameters, crystal structure, and bonding at the interfaces between materials used to make the devices, from the misorientation of crystallites within the materials, or from dangling or frustrated bonds.

In providing these interfaces, films that are crystalline must be grown on other films and on substrates. One way of growing the crystal layers is by a process called “epitaxy,” that is a process wherein a crystal of one material is grown on a crystal of another material such that both crystals have a related structural orientation. The epitaxy process generally results in oriented, single crystal (or, at least, crystal) growth that can minimize interface problems. Epitaxial films also provide greater film uniformity than polycrystalline films. This is important in reducing “media noise” in any data storage device that relies on these films. Furthermore, epitaxial growth can eliminate problematic grain boundaries. For the class of materials considered here, epitaxial growth can also result in surfaces with better electrical properties and morphology. Accordingly, it is desirable to use materials that can be grown epitaxially, so that the materials have a minimum of defects that interfere with the detection characteristics.

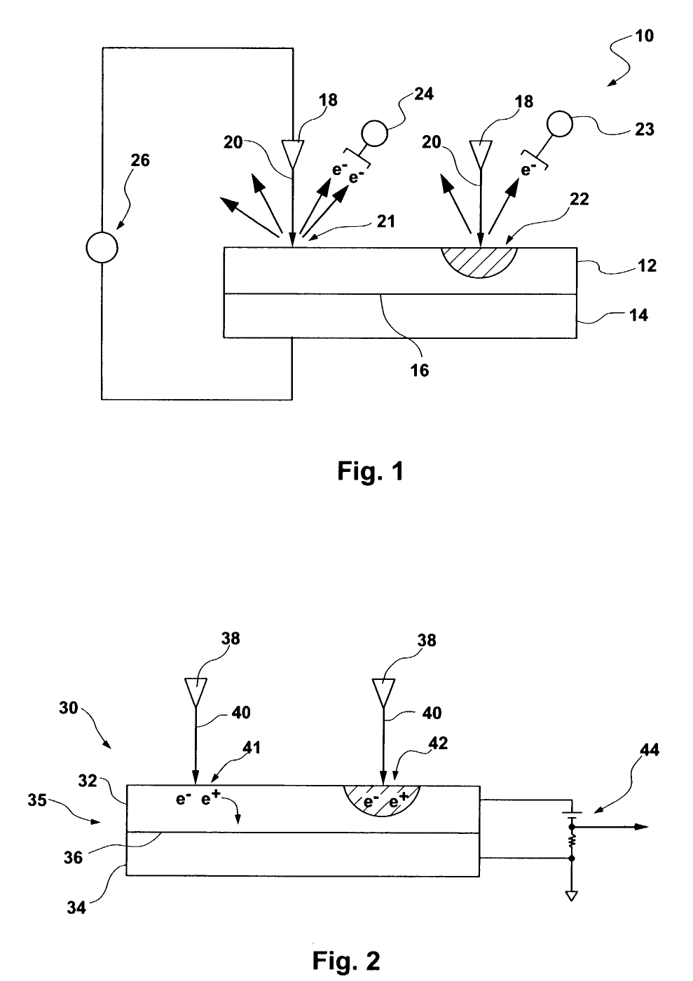

The importance of using the right materials is particularly apparent when examining the various devices for providing storage media and sensing the data in the storage media. Examples of devices that utilize such data storage media are photodiodes, cathododiodes, phototransistors, cathodotransistors, photoconductors, cathodoconductors, cathodoluminescent devices, photoluminescent devices, photoluminescent devices having a luminescent layer over a phase-change layer, and combinations of the same. The word “photo” refers to the use of light beams as the energizing source, whereas, the term “cathodo” refers to electron beams providing the energy to the device. Examples of these devices are shown in FIGS. 1-6, to be discussed later.

In a cathodoconductive storage device, a material is needed that exhibits strong cathodoconductivity in one of its states. In order to achieve high areal storage densities the material must also be capable of uniform cathodoconductive properties over short length scales. In thin film form, many of the phase-change materials that have been considered for this application in the past are difficult to grow epitaxially on desirable substrates (such as silicon) and are typically polycrystalline. This leads to problems with uniformity as well as grain boundaries that limit carrier mobilities and/or lifetimes (and, therefore, the cathodoconductivity). Many of these materials also have other problems that limit the cathodoconductivity such as high surface recombination rates or defect levels that result from the strain, grain boundaries, mis-oriented growth, and so forth, that often accompany non-epitaxial growth. In some cases, even prior epitaxial films can be plagued by surface or interface problems resulting from things like dangling bonds.

The cathodotransistor and phototransistor storage devices typically rely on many of the same material properties as do the cathododiode and photodiode devices and suffer from many of the same shortcomings of the conventional semiconducting phase-change materials described above.

The cathodoluminescent or photoluminescent storage devices require a material that provides strong luminescence in one of its states. Many of the polycrystalline films that have been explored for this application contain non-radiative defects that quench the luminescence or defects that result in luminescence at undesirable wavelengths (e.g. states in the bandgap that cause radiative recombination at longer wavelengths).

These defects can be caused by the type and increased number of grain boundaries that can result from non-epitaxial growth. Non-epitaxial growth can also cause strain that results in undesirable defects. Non-epitaxially grown films are also difficult to make uniform on small length scales, as required for high areal density data recording. Furthermore, many of the conventional materials that are being used in this type of data storage device have surfaces or interfaces that contain undesirable defects (e.g. dangling bonds) that compromise the luminescence, particularly when stimulated by low-energy electron read beams or high-energy photon read beams that have a short penetration depth, in which case all the electron-hole pairs generated by the read beam are created near the surface where they are more strongly affected by surface defects.

In a data storage device having a luminescent layer over a phase-change layer, as in application Ser. No. 10/231044, described above, the luminescent layer can suffer from many of the same problems as the luminescent phase-change layer in the simple luminescent devices described above. In addition, the phase-change layer may suffer from uniformity problems and poor optical properties (e.g. absorption at undesirable wavelengths in one of its states) if it is not a single crystal (e.g. an epitaxial film). Furthermore, a polycrystalline or defective phase-change layer (e.g. one with dangling bonds at its surface) may cause non-radiative recombination, or recombination at an undesirable wavelength, at its interface with the luminescent layer. A polycrystalline or defective phase-change layer may also cause the overlying luminescent layer to grow with undesirable defects.

Accordingly, a group or set of materials is needed, for ultra-high density storage devices, that are suitable for acting as phase-change materials and/or for other layers in the devices and that form clean layer interfaces with a minimum of loose or dangling bonds and other defects that can cause undesired recombinations, band-bending and other distortions. Moreover, a group or set of materials is needed for forming clean bonding interfaces in various types of detection devices having good structural uniformity resulting in less media noise. A group or set of materials is needed that can be grown on a variety of layers and substrates in both epitaxial and non-epitaxial forms. Also, a group or set of materials is needed for the luminescent layer in a phase-change material ultra-high density storage device, wherein the material is spatially uniform and has a sufficiently low number of defects, particularly surface defects and grain boundaries that would compromise its luminescence.

As part of the inventive activity described herein, materials have been considered that would be suitable for the above devices and conditions. At least one class of materials has been examined herein that exhibits such effective bonding characteristics. These materials are called two-dimensional (2-D) materials. As used herein, the terms “two-dimensional materials,” “two-dimensional layer,” “2-D layer,” “2-D film” and 2-D substrate” refer to anisotropically bonded materials, including materials that form layers adhered internally by strong internal bonding, such as strong covalent or ionic bonds, and are connected to adjacent layers by relatively weak interlayer bonds, primarily van der Waals (vdW) forces (relatively weak forces that stem primarily from induced dipole-dipole attractions) or, alternatively, relatively weak covalent or ionic bonds.

Two-dimensional layers typically exhibit relatively strong internal bonding within layers, primarily caused by covalent or ionic forces. See, e.g., Jaegermann et al, “Electronic Properties of van der Waals-epitaxy Films and Surfaces,” Physics and Chemistry of Materials with Low-Dimensional Structures, vol. 24, pp. 317-402. Thus, two-dimensional layers are formed that can be easily terminated leaving surfaces that are relatively free from problematic defects such as recombination or trapping sites. Many chalcogen-based materials, based on selenium, tellurium or sulphur, form structures that exhibit this vdW layering effect. Many chalcogenide materials have also been found to have numerous characteristics that make them suitable for phase-change materials.

It is preferred that high quality semiconductor interfaces be prepared using materials wherein the lattice parameters of the substrate and overlayer of similar symmetry differ by no more a small amount, typically around a few percent. Beyond that limitation, stress or strain in the overlayer lead to defective formations at or near the interface. However, because of the anisotropy between interlayer and intralayer bonding strengths in some two-dimensional materials, the lattice mismatch can extend substantially beyond the usual low limitation while still allowing for the growth of relatively defect free epitaxially layers. See, for example, Jaegermann, et al, “Perspectives of the Concept of van der Waals Epitaxy,” Thin Solid Films 380 (2000) 276-281. In some cases, such two-dimensional, layered materials have also been grown epitaxially on lattice-mismatched three-dimensional materials.

In some instances, this 2-D on 3-D growth is facilitated by the formation of interface layers with vdW-like surface terminations during the initial stages of growth. E.g., GaSe is believed to grow epitaxially on Si(111) by first forming a Si—Ga—Se interface layer (GaSe half sheet) (see, for example, Shuang Meng, et al, “Low Energy Photoelectron Diffraction Structure Determination of GaSe-bilayer-passivated Si(111),” Phys. Rev. B, 64 (2001) 235314, and references therein).

By way of further background, the data storage and detection devices shown in FIGS. 1-6 will be briefly explained.

### Secondary Emission Device

In FIG. 1, a data storage and retrieval device 10 is shown. A semiconductor layer 12 is deposited or grown on a substrate 14 forming an interface 16. Layer 12 has data storage capabilities such as the ability to change phases or states with the application of energy. To write data, emitters 18 selectively direct a beam 20 of electrons or photons onto the surface of layer 12 as desired to alter the state of the layer in data storage location 22.

Typically, the unaltered state is a crystalline state and the altered state is an amorphous state. For ultra-high density data storage, the storage areas typically have dimensions in the 10-100 nanometer range, or in the hundreds of nanometer range. Microfabricated micromovers are preferably used to scan the array of emitters over the storage areas 21, 22.

In the data reading process, emitters 18 direct electrons of lower power density to the surface of layer 12. The energy of the beams causes a reflection of electrons away from the surface, composed of secondary and backscattered electrons. These electrons are captured by electron collectors 23 or 24. The amount of this secondary and backscattered emission varies depending on the state of the layer 12 in the location being read. As shown in this example, more electrons are emitted to the collector 24 from an unaltered crystalline state of layer 12 than electrons emitted to the collector 23 from an altered amorphous state. A further detailed description of the data writing and reading processes is found in the Gibson 596 Patent.

### Photodiode and Cathododiode Devices

Looking now at FIG. 2, an embodiment is shown involving a photodiode (light beams) or cathododiode (electron beams) data storage and retrieval device 30. A data storage layer 32 is disposed on an additional layer 34 to form the diode 35. The diode can be any type that provides a built-in field for separating charge carriers, such as a p-n junction, pin-junction or Schottky barrier device, depending on the materials used.

Emitters 38 direct light beams or electron beams onto the storage layer 32. As in FIG. 1, a data bit is written by locally altering the state at areas 42 of the storage layer 32. The different states of the storage areas 42 provide a contrast in bit detection during the read function.

During the read function, the emitters 38 emit a lower power density beam to locally excite charge carriers in the storage areas 41 and 42 of the diode 35. If carriers are excited in the storage layer 32, the number of carriers created (the “generation efficiency”) will depend on the state of the storage areas 41, 42 where the light or electron beams 40 are incident.

Among the factors that affect the generation efficiency are the band structure of the storage layer and geminate recombination. Some fraction of the generated carriers of one sign (electrons or holes) will be swept across the diode interface 36 (the “collection efficiency”) under the influence of a built-in field. An additional field may be applied across interface 36 by a voltage source 44. The current that results from carriers passing across the diode interface 36 can be monitored by a detection signal taken across the interface 36 to determine the state of data storage areas 41, 42. The collection efficiency is dependent upon, among other things, the recombination rate and mobility in and around the area on which the read photons are incident and the effect of the built-in fields.

Thus, variations in the current generated across the diode 35 by the read photons or electrons can depend on both the local generation efficiency and the local collection efficiency. Both of these factors are influenced by the state of the region upon which the photons or electrons are incident. The phase-change material of storage layer 32 can be comprised of a number of phase change materials, such as chalcogenide-based phase-change materials, with the appropriate electrical properties, such as bandgap, mobility, carrier lifetime and carrier density.

### Phototransistor and Cathodotransistor Devices

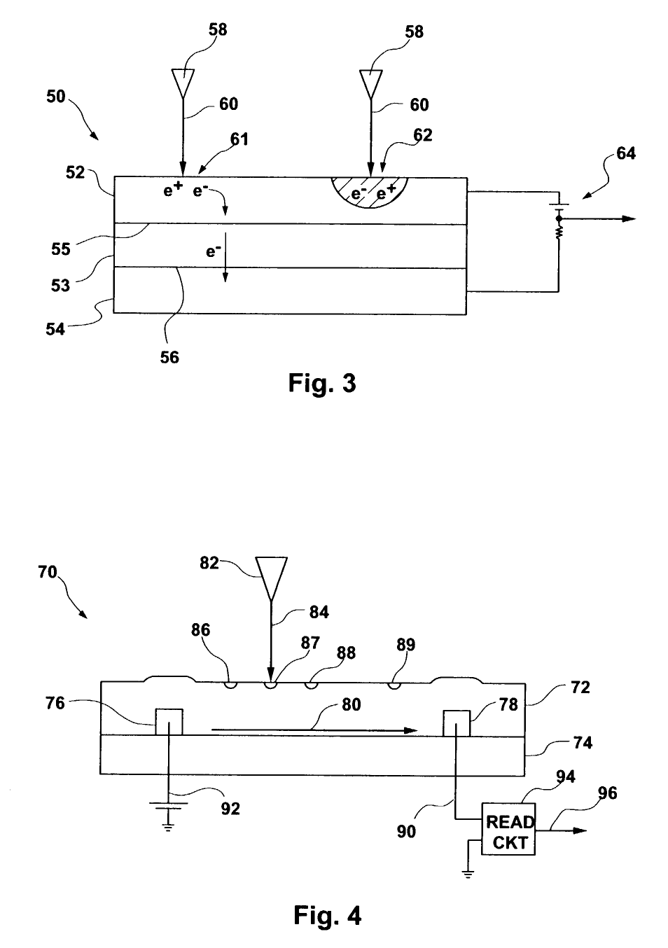

Referring now to FIG. 3, a phototransistor or cathodotransistor data storage and retrieval device 50 is shown. The device functions somewhat similarly to the photodiode and cathododiode devices shown in FIG. 2, except that a third layer is added to serve as a base to control the device. Specifically, a top semiconductor layer 52 is provided that has phase change capabilities, as described herein. Then a base layer 53 is disposed below the top layer 52. Finally, a third semiconductor layer 54 is disposed below layer 53 and may be disposed on a substrate layer (not shown). Typically, layers 52, 53 and 54 are arranged as p-n-p or n-p-n layers. In FIG. 3, the layers are arranged as n-p-n, with electron carriers moving through the layers, as shown. In either case, layers with appropriate bandgaps, electron affinities, and doping levels must be chosen, as understood in phototransistor prior art.

A voltage source 64 biases layers 52 and 54 to promote the flow of carriers, electrons or holes, depending on the materials used. In the case of n-p-n layers, the n-p junction 55 between layers 52 and 53 is forward biased and the p-n junction 56 between layers 53 and 54 is reverse biased. Without the generation of carriers in the top layer 52 by the read beam, the flow of majority electrons from the top n-layer 52 to the bottom n-layer 54 is impeded by the reverse-biased junction 56. When the beam is incident on an unwritten region 61, some of the generated carriers diffuse to the middle layer 53, changing the density of electrons and holes there. The structure can be engineered such that these carrier density changes result in a lowering of the energy barrier for the transport of electrons across the junction 56. This results in a measurable increase in the current flowing across the device. When the read beam is incident on a written region 62, many of the generated carriers are rapidly recombined and the efficiency with which the carrier densities are altered in the middle, “gate” layer, is reduced. Consequently, a lower current is measured across the diode than when the beam is incident on an unwritten region 61. Although there is no lead attached to the base layer 53, it indirectly controls the flow of current between the n layers 52 and 54. The modulation of the current flowing across the device can be much larger than the read beam current.

### Photoconductive or Cathodoconductive Devices

With reference now to FIG. 4, a photoconductive or cathodoconductive type of data storage and retrieval device 70 is shown. As described above, data is stored in a top photoconductive or cathodoconductive layer 72 comprising a phase-change material by altering the state or phase of the material at selected data storage areas 86-89. An electrically insulating substrate 74, such as silicon with an oxidized top layer, is provided below the data storage layer 72.

The photoconductive or cathodoconductive layer 72 is preferably made of a chalcogenide-based phase-change material having a high “dark” resistivity when not impinged upon by an energy beam. Layer 72 may include a single layer of photoconductive or cathodoconductive material, multiple layers of the same type of photoconductive or cathodoconductive material or multiple layers of different photoconductive or cathodoconductive materials.

A plurality of spaced apart electrodes, such as electrode pair 76 and 78, make contact with the photoconductive or cathodoconductive layer 72. The photoconductive or cathodoconductive material of layer 72 may be deposited over or under electrodes 76 and 78. A data storage region is located between electrodes 76 and 78, including multiple spaced-apart data storage areas 86-89, as shown in FIG. 4. The storage areas may be arranged in rows and columns, with the state of each area being determinative of the data stored therein.

An array of beam emitters 82 direct light beams or electron beams onto the photoconductive or cathodoconductive layer 72. As described above, the beams 84 have appropriate time and power parameters to change the state of the storage areas 86-89 between amorphous and crystalline states or between different crystalline states.

A power supply 92 applies a bias voltage across the electrodes 76 and 78 during the read function. This bias voltage induces an electric field 80 in the plane of the photoconductive or cathodoconductive layer 72. The power supply 92 may be fabricated on the substrate 74 or may be provided outside the chip.

During read operations on the storage areas 86-89, light or electron beam 84 is scanned between electrodes 76 and 78 while the bias voltage is applied to the electrodes. When the beam 84 impacts a storage area 86-89, electron carriers and hole carriers are produced and accelerated by the electric field 80 toward either electrode 76 or electrode 78, depending upon the sign of their charge and the direction of the applied field. This movement of electrons and holes causes a current to flow, which is detected by a read circuit 94 to provide an output signal 96.

Assuming a constant intensity of the beam 84, the rate at which electrons and holes are generated depends upon the state of the storage areas 86-89. If a phase-change material is used, a contrast in photocurrent magnitude results from the difference in material properties between written and unwritten areas. Because the geminate recombination rates are different for written and unwritten areas, there is a difference in the rate at which free carriers are generated. Geminate recombination rate means the rate at which initially created electron-hole pairs recombine before they are separated into free carriers.

Further current magnitude contrast may be obtained from differences in the lifetime or mobility of the free carriers for written and unwritten areas. For example, in general, the mobility will be lower and carrier lifetime will be shorter in an amorphous material than in a crystalline material. Additional contrasts may arise from differences in resistivity and effects at the interface between written and unwritten areas such as the creation of built-in fields. By monitoring the changes in the magnitude of the photocurrent, the states of the storage areas 86-89 can be determined. The output 96 from read circuit 94 may be amplified and converted from analog to a digital value if desired.

### Photoluminescent and Cathodoluminescent Devices

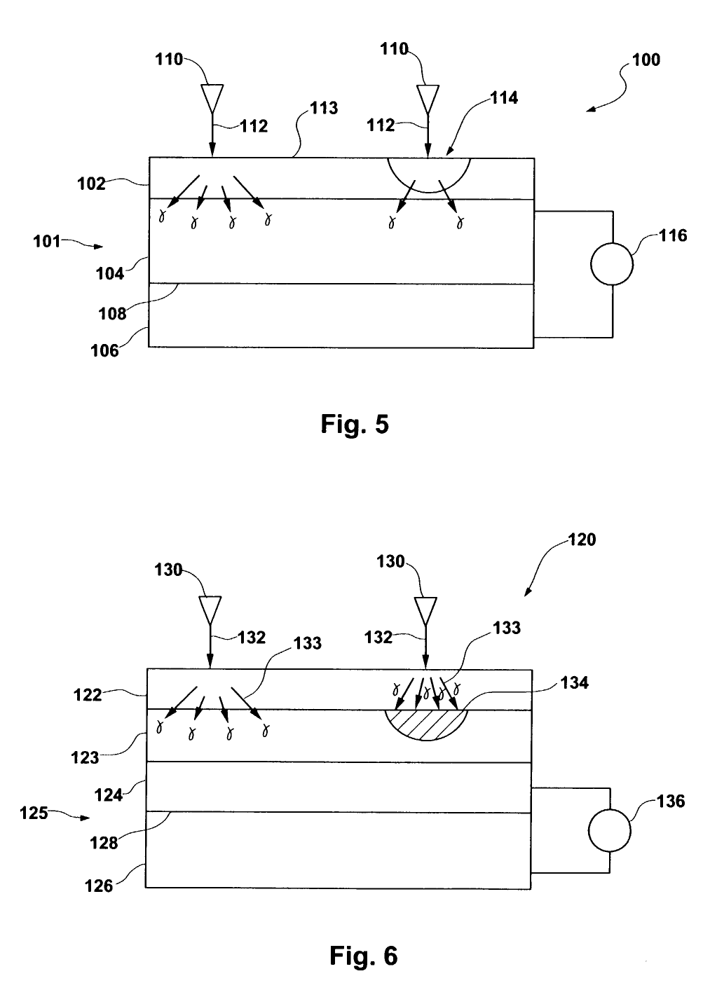

Referring now to FIG. 5, a photoluminescent or cathodoluminescent data storage and retrieval device 100 is shown. In this device the activity of the electron-hole pairs generated during the read process is detected via their radiative recombination. The storage layer is a photoluminescent or cathodoluminescent phase-change material in one of its states. Potentially, multibit recording can be used if the phase-change material exhibits multiple states that provide contrasting luminescent properties. For example, the material could luminesce at different wavelengths or with different amplitudes in each state. Photodetectors, such as photodiodes or microfabricated photomultiplier tubes may be used for photon detection.

As shown in FIG. 5, a photodiode 101 has a photodiode interface 108 between upper layer 104 and lower layer 106. A storage layer 102 composed of photoluminescent or cathodoluminescent phase-change material is deposited on the surface of upper layer 104. Beam emitters 110 direct light or electron beams 112 onto the surface of the data storage layer 102.

Data is stored in the storage layer 102 by applying the beams 112 in selected storage areas 114 to alter the light-emitting properties of the photoluminescent or cathodoluminescent storage layer. The photoluminescent or cathodoluminescent material can be any one of a number of chalcogenide-based phase-change materials. The light emitting properties may be altered in a number of different ways, such as by changing the electronic band structure, i.e., from a direct band gap material to an indirect band gap material, by altering the ratio of the non-radiative to radiative recombination rates, or by changing the wavelength or escape efficiency of the light emitted by the material.

During the read mode, beams 112 have a lower power intensity to prevent undesired writing. The written storage areas 114 will emit a different number of photons and/or photons at a different wavelength than the other areas 113 on the storage layer 102 that have not been written. The emitted photons will generate a current of electron and hole carriers in the photodiode 101, some of which will cross the photodiode interface 108. A meter 116 connected between the layers 104 and 106 of photodiode 101 measures the current or voltage across the photodiode interface 108 as each storage area is impacted by a beam to determine whether each storage area has been altered to store data bits. Contrast in the wavelength of the emitted photons can be utilized in this detection scheme if photodetectors are used that are more sensitive to wavelengths emitted preferentially from one of the states.

### Photoluminesent and Cathodoluminesent Devices With Separate Data Layer

Referring to FIG. 6, another photoluminescent or cathodoluminescent data storage and retrieval device 120 is shown. Device 120 is similar to the photoluminescent or cathodoluminescent data storage and retrieval device 100 shown in FIG. 5, except that the data storage layer 123 is a separate layer positioned beneath the top luminescent layer 122.

Separating the luminescent function from the phase change function enables the selection of materials that are optimal for each of the two functions.

Various types of photodetectors may be used for detection. As shown here, a photodiode 125 is composed of semiconductor layers 124 and 126 having an interface 128. A meter 136 connected between the layers 124, 126 of photodiode 125 measures the current or voltage across the photodiode interface 128 as each storage area is impacted by a beam to determine whether each storage area has been altered to store data bits.

Information is stored by using an electron or photon beam 132 from an emitter 130 to locally alter the reflectivity and/or absorptivity of the phase-change layer 123. To read a bit, light emission 133 is stimulated in the luminescent layer 122 using an electron or photon beam 132. The light 133 stimulates the flow of carriers, electrons or holes, that are detected as they cross the interface 128. The amount of this light emission 133, of a wavelength to which the photodetector is sensitive, that reaches photodiode 125 is influenced by the reflectivity and/or absorptivity of the phase-change layer 123. These characteristics are influenced by the presence of a bit in data storage area 134, so that data detection is enabled.

### Van der Waals Layers in Data Storage and Detection Devices

The present invention utilizes the characteristics and advantages of the layered nature of certain chalogenide materials and the weak van der Waals bonding between the layers. These two-dimensional van der Waals materials have properties that are beneficial to the creation and operation of media structures in the devices described above.

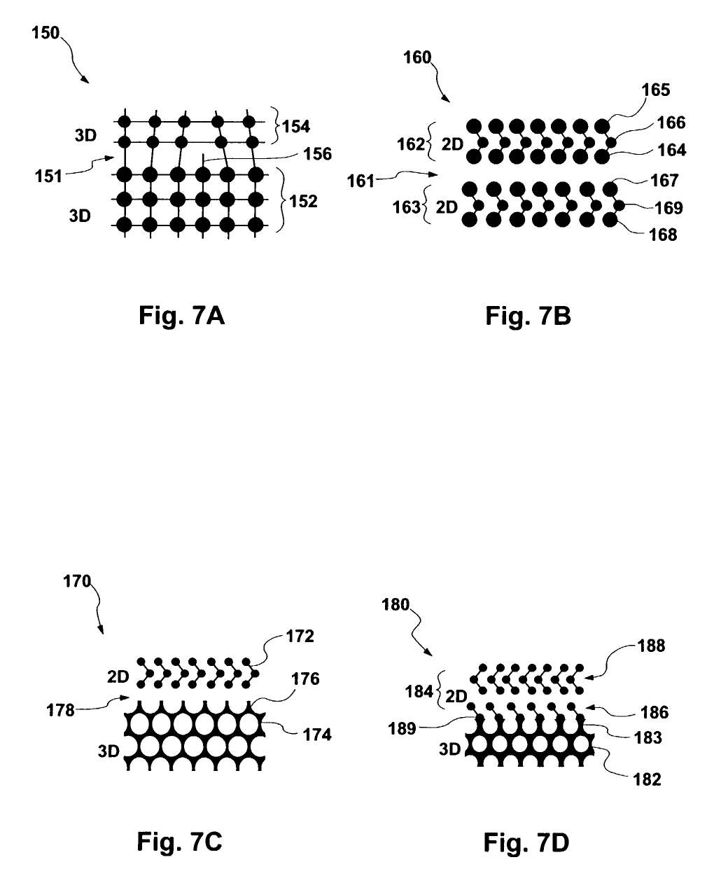

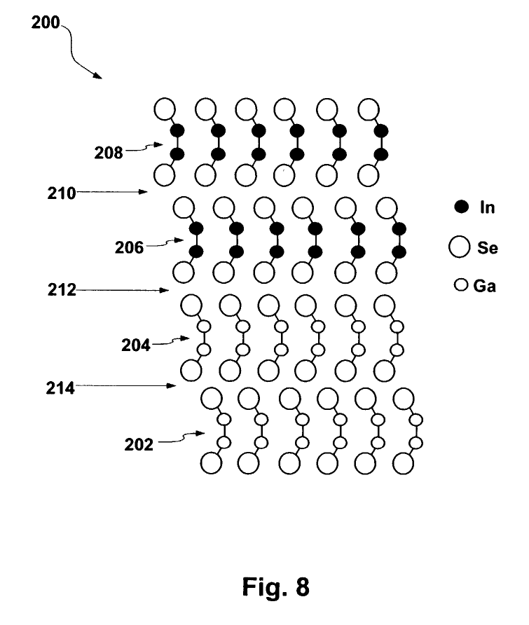

With reference to FIGS. 7A-7D, typical bonding characteristics of some two and three-dimensional materials are shown. FIG. 7A illustrates a conventional epitaxial structure 150 between two three dimensional crystals with different structures. Strong, directional covalent bonds can lead to strain and/or structural defects such as dangling bonds when there is a lattice mismatch between the two materials. FIG. 7a depicts a bond site 156 in crystal structure 152 that does not have a corresponding bond in crystal structure 154. This dangling bond 156, repeated many times at the interface 151 causes discontinuities, stresses and strains at the interface 151, resulting in electrically active defects that lead to problems in data detection. Strain and/or structural defects at the interface 151 can also lead to further defects in the bulk of a 3-D film during its growth on a lattice-mismatched 3-D substrate, resulting in further problems in media uniformity and data detection.

In contrast, FIG. 7B shows a crystalline structure 160 involving sheets of different two-dimensional materials 162 and 163. The sheet 162 consists of two atomic layers 164 and 165 of a first element tightly bonded with an atomic layer 166 of a second element. The sheet 163 consists of two atomic layers 167 and 168 of a third element tightly bonded with an atomic layer 169 of a fourth element. Bonding of the elements within each sheet takes place primarily by covalent or ionic forces. Thicker films of these materials consist of stacks of sheets primarily bonded by weak van der Waals forces (not shown). The two sheets 162 and 163 are also loosely bonded at the heterointerface 161 primarily by van der Waals intermolecular forces. This bonding is sufficient to give orientation to a heteroepitaxial film but too weak to cause any substantial strain at the interface 161. It also does not result in frustrated or dangling bonds.

This type of layered bonding results in two dimensional (2D) epitaxial layers with relatively clean and inert interfaces that minimize defects, stress and strain at the interface and result in the growth of more defect free films..

Looking now at FIG. 7C, a crystalline structure 170 is shown in which a two-dimensional material 172 is grown on a 3D material 174. In this case, the interface 178 is a heterojunction between two dissimilar materials. The 3D material has unterminated bonds or open bonding sites 176 that are not intercepted by the two-dimensional material 172. This process is sometimes referred to as quasi-van der Waals epitaxy where polar bonding sites attract opposing polar regions of the two-dimensional material.

FIG. 7D shows a crystalline structure 180 in which the bonds 183 of 3D material 182 are terminated by a half sheet 186 of the two-dimensional material 184 formed during the epitaxial growth process. In this manner, the surface of material 182 takes on a 2-D-like structure and bonds loosely with the next layer 188 of two-dimensional material. For example, if the 3D material is silicon and the 2D material is gallium-selenium, the full sheet of the two-dimensional compound might be structured as selenium-gallium-gallium-selenium. In this case the half sheet of two-dimensional layer would be gallium-selenium, and the gallium atoms 189 and Se atoms 186 would bond with the unterminated silicon surface in such a way as to leave a two-dimensional like surface, without dangling bonds, as shown.

Two-dimensional layered materials according to the present invention include but are not limited to the “included class of two-dimensional materials” previously mentioned.

As discussed above, this class of materials is characterized by strong covalent or ionic bonding within layers and primarily weak van der Waals bonding between layers. For example, the compounds InSe, InTe, GaSe, and GaS, can exist in a crystal structure that consists of sheets comprised of four planes of atoms that repeat in the sequence chalcogen-M-M-chalcogen (M=Ga or In).

FIG. 8 shows such a structure, in which two sheets 202, 204 of GaSe are loosely connected primarily by vdW bonding at the interfaces 212 and 214. Two sheets of InSe 206, 208 are stacked on top of the two sheets 202, 204 of GaSe. The bonds within each of these four layer sheets tend to be strong covalent or ionic bonds (typically, the metal atoms are covalently bonded to one another and ionically bonded to the neighboring chalcogens). However, there is primarily only weak vdW bonding between the chalcogen layers at the top and bottom of each four-layer sheet. This weak vdW bonding makes possible many of the advantages of the present invention.

Free surfaces of the two-dimensional layered materials of the present invention are, typically, free of the dangling covalent or ionic bonds that plague the surface electronic properties of many conventional semiconductors such as silicon. Consequently, the surfaces of these 2-D materials have been observed to be relatively free of problems due to surface recombination, surface band-bending or Fermi level pinning, and electronic surface traps. Free surfaces are also relatively immune to active adsorption of some contaminants. These factors are particularly important in devices that utilize low energy electrons or high energy photons to create a readback signal. In these cases, the read beams create electron-hole pairs only very close to the surface. Therefore, the readback signal in these devices is very sensitive to surface problems.

Interfaces between two of these layered two-dimensional materials also typically have fewer electronic and structural problems than heterojunctions between non-2-D semiconductors. Because of the weak interaction between two two-dimensional materials at their interface, the materials suffer fewer effects of lattice mismatch and strain. If one two-dimensional material is deposited on another two-dimensional material , the weak vdW bonding between the two can allow the deposited film to grow relatively unstrained. In some cases, the deposited film is highly oriented with respect to the substrate. This is what has been termed van der Waals epitaxy (vdW-epi). These interfaces typically don't have the problems with dangling bonds that plague many non-vdW heterojunctions.

Interfaces between a layered two-dimensional material and a non-two-dimensional material also often have fewer electronic and structural problems than interfaces between two non-2-D materials. As shown in FIGS. 7C and 7D, in some cases, epitaxial growth of a two-dimensional material on a non-2-D material is possible. This process is called quasi van der Waals epitaxy, or simply quasi-vdW-epi.

In addition to better interfaces and surfaces, vdW or quasi-vdw epi-layers typically have better electrical and optical properties than non-vdW overlayers. This is because the lack of strain at the interface results in the growth of films with fewer structural defects and grain boundaries that can degrade the electrical and optical properties. Such degradation is likely to result in shorter carrier lifetimes, lower carrier mobilities, carrier densities that are too high or too low, defect levels in the bandgap, defects that frustrate intentional doping attempts, and other undesirable results.

There are many other potential benefits to utilizing vdW-epi or quasi-vdW-epi in the manufacture of ultrahigh density storage media as well. These include, but are not limited to, better film uniformity, increased ability to dope films (due to a reduction in defects, such as grain boundaries, that can frustrate doping efforts) and more options for substrate materials, including, for example, insulating substrates that would allow for electrical isolation of the devices.

There can be advantages to growing a two-dimensional material on a non-two-dimensional material (or vice versa), or a two-dimensional material on another two-dimensional material, even without epitaxy. For example, one of the issues in making data storage diodes with a phase-change layer, as described in the Gibson 596 Patent, is that it can be difficult to dope many of the phase-change semiconductors that one would like to use, many of which are chalcogenide based. At the same time, there are many potential advantages to using a homojunction, such as the lack of band offsets that can impede carrier collection and interfaces with fewer electrical problems. However, creating pn homojunctions requires the ability to dope the semiconductor that is used.

A potentially attractive alternative is to make a junction that is nearly a homojunction by using two similar materials, one of which prefers to be p-type and the other of which prefers to be n-type. As an example, InSe is a semiconducting chalcogenide that can be reversibly changed between the amorphous and crystalline states. Without intentional doping InSe is usually n-type. For a variety of reasons, including its large electron affinity and numerous compensating defects, it is difficult to dope polycrystalline InSe films p-type. However, GaSe, another layered chalcogenide semiconductor, is very similar structurally and electrically to InSe and is naturally p-type (in part because of its much lower electron affinity). Thus, referring again to FIG. 8, a pseudo pn-homojunction 212 between InSe and GaSe can be formed that provides many of the benefits of a true homojunction.

Epitaxy between these materials is not needed to reap many of the benefits of the similarity between the two materials. At the same time, the similarity of the crystal structure and bonding of the two materials could lead to interfaces between grains, both within one material and between materials, that have fewer electrical problems than grain boundaries in more heterogeneous pairs of materials. Also, the similarities between these two materials could lead to preferred orientations for the growth of one material on the other, without true epitaxy. This, in turn, leads to better electrical properties by, for example, reducing the mismatch at interfaces and grain boundaries.

Finally, the vdW bonding between layers in these materials can reduce the electrical problems that often result at mismatched interfaces or grain boundaries, or at the surfaces of semiconductors. InSe/GaSe is just one example of a pseudo pn-junction between layered chalcogenide semiconductors—many other possible pairs exist. Note that the benefits that derive from non-epitaxial pseudo pn-junctions can be obtained from devices grown on a variety of insulating substrates or metal contact layers, as desired.

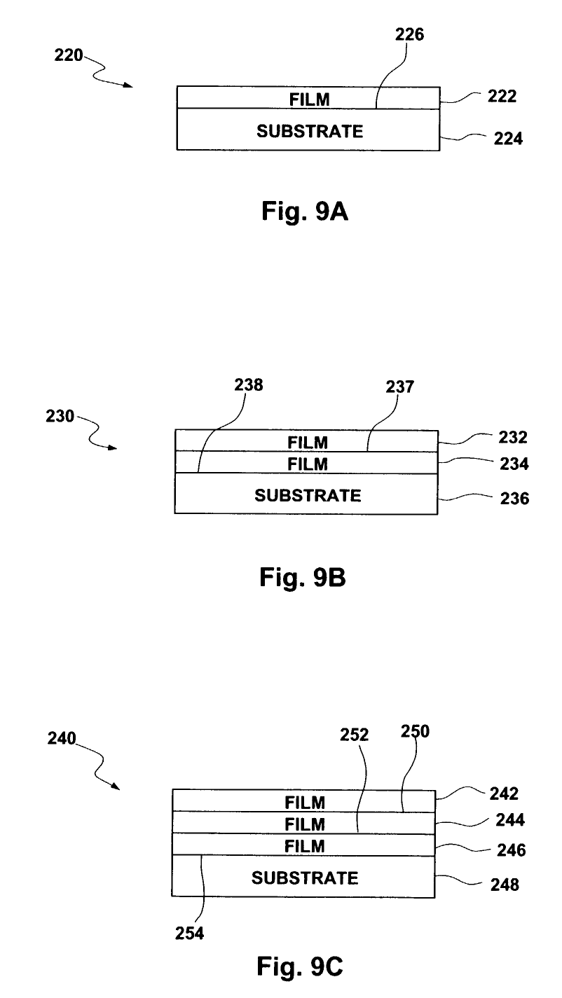

Referring now to FIGS. 9A-C, some possibilities are shown for using a two-dimensional layer in one of the data storage/detection devices previously described. Possible storage medium structures that can benefit from the properties of two-dimensional materials include:

2-D film/2-D substrate

2-D film/non-2-D substrate

non-2-D film/2-D substrate

2-D film/2-D film/X

2-D film/non-2-D film/X

non-2-D film/2-D film/X

In most of the above combinations, the 2-D film is a chalcogenide-based phase-change material, the 2-D and non 2-D films can be semiconductor, metal, or insulator, and the term “X ” can mean a substrate or film made of a material that is (1) 2-D or non-2-D and (2) metal, semiconductor or insulator.

In other words, as shown in FIG. 9A, the combination structure 220 can include a film 222, 2-D or non-2-D, disposed on a substrate 224 that can be two-dimensional if the film is 2-D or non-2-D, and that is a two-dimensional substrate if the film is non-2-D, so that there is always at least one two-dimensional material at the interface 226. This structure 220 would be useful for storage/detection devices such as the secondary/backscatter emission device 10 shown in FIG. 1, the diode device shown in FIG. 2, or the cathodoconductivity/photoconductivity device shown in FIG. 4.

Likewise, as shown in FIG. 9B, the combination structure 230 includes a film 232 over a film 234 over a substrate 236, at least one of which is a two-dimensional material, so that at least one of the interfaces 237 and 238 is formed by at least one two-dimensional material. This structure 230 could be utilized for photodiode and cathododiode devices, as shown in FIG. 2. In this case, the diode could be formed between the two films with the substrate acting as a contact or as an insulator. The substrate could also act as a template for the epitaxial growth of the films. Alternatively, the diode could be formed between the substrate 236 and the film 234, with the film 232 acting as a contact or capping layer. Alternatively, 232, 234, and 236 could form a graded junction or p-i-n diode. The structure 230 could also be utilized for the photoconductive and cathodoconductive devices shown in FIG. 4. In this case, one possibility is for layer 234 to be a photoconductive or cathodoconductive 2-D layer, layer 232 to be a protective cap, and substrate 236 to be a substrate for the epitaxial growth of layer 234.

The structure 230 could also be utilized for the phototransistor or cathodotransistor devices 50 shown in FIG. 3. In this case, the materials of 232, 234, and 236 would form the phototransistor or cathodotransistor. Using a 2-D material for at least one of these three layers would provide many of the structural and electrical benefits described above. The structure 230 could also be utilized for the photoluminescent or cathodoluminescent device 100 shown in FIG. 5 with one or more of the materials 232, 234, and 236 being a 2-D material. In this case, the luminescent properties and uniformity of the luminescent layer could be improved through the use of layered, 2-D materials, as described above.

FIG. 9C shows a combination structure 240 in which there are three film layers 242, 244 and 246 over a substrate 248. This structure 240 would be useful for the phototransistors and cathodotransistors 50 shown in FIG. 3 and for the photoluminescent and cathodoluminescent devices 120 shown in FIG. 6. At least one of the materials in 242, 244, 246, and 248 would be a two-dimensional material, so that the desirable advantages of two-dimensional layers can be utilized.

Note that a structure with many layers such as is shown in FIG. 9C could also be utilized for any of the storage devices discussed here. For example, simpler devices such as the secondary/backscatter device of FIG. 1 or the photoconductivity/cathodoconductivity device of FIG. 4 could incorporate protective capping layers, contact layers, buffer layers, or electrical isolation layers that increase the total number of required layers.

Some of these structures will benefit from two-dimensional epitaxial growth or quasi-vdW epitaxial growth of one material on another. In other cases, it may be possible to grow polycrystalline formations without epitaxy. In all cases, these structures can potentially benefit from the two-dimensional nature of the interlayer bonding in the two-dimensional materials, with or without epitaxy (e.g. when the films or substrates are polycrystalline or even amorphous).

### SPECIFIC EMBODIMENTS UTILIZING TWO-DIMENSIONAL LAYERS

### EXAMPLE 1

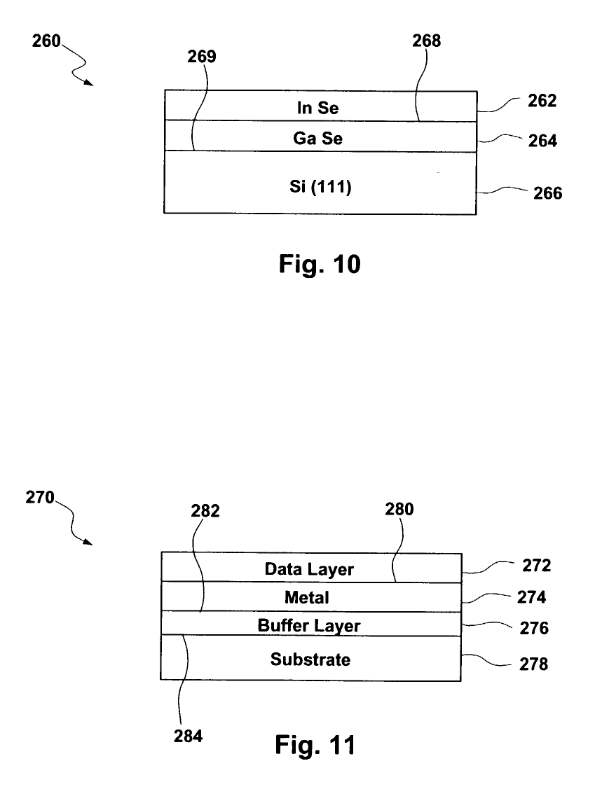

An embodiment structure 260 of the present invention is shown in FIG. 10, as it pertains to diode storage media structures, such as that described with respect to FIG. 2. A quasi-vdw-epi layer 264 of p-type GaSe is grown on Si(111), similar to the approach taken in FIG. 7D. GaSe is readily grown epitaxially on Si(111), despite the lattice mismatch. A vdW-epi layer 262 of n-type InSe is then grown on the GaSe. A combination of InSe/GaSe results, similar to that shown in FIG. 8 except that the combination is formed on the silicon substrate. Alternately, InSe may be grown directly on a GaSe crystal, without using a silicon substrate.

The InSe/GaSe/Si combination forms junctions at the InSe/GaSe and GaSe/Si interfaces 268 and 269 having low interface and surface recombination, high spatial uniformity, relatively high mobility and long carrier lifetimes compared to polycrystalline films, few grain boundaries, and that are relatively smooth and flat.

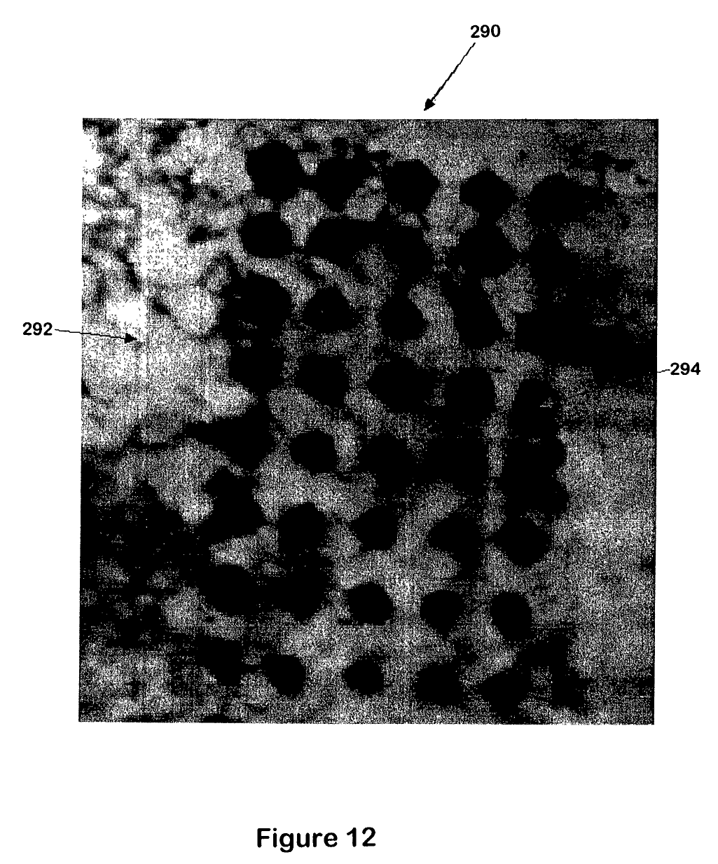

An example of one experiment is given in the image shown in FIG. 12. This image consists of a diode 290 formed by growing a 400 nm epitaxial InSe film on a GaSe crystal. The image in FIG. 12 was created by monitoring the current induced across the diode 290 while raster scanning a 2 keV electron beam across it. The gray scale is proportional to the induced current, with brighter regions 292 indicating a larger current. The spots 294 in the image are amorphous regions that were created by locally melting and then quenching the InSe. Electron Beam Backscatter Diffraction (EBSD) measurements confirm that these spot regions 294 are amorphous, as confirmed by Transmission Electron Microscope (TEM) measurements on similar samples. Note that contrast in the diode current can also be observed even when electron beam energies well below 1 keV are used to read the bits.

Similar results have been obtained using epitaxial InSe films that were grown on epitaxial GaSe films that were grown, in turn, on Si(111) substrates. These films were grown by coevaporation of the elemental constituents onto heated Si(111) substrates in an ultra-high vacuum chamber (base pressure in low 10⁻¹⁰ torr range).

The foregoing experiments demonstrate the following:

The InSe/GaSe combination forms a good, low-leakage diode, with interfaces and transport and electrical properties of sufficient quality to provide signal gains of greater than 30 at 2 keV and greater than 10 at 1 keV in unwritten regions. The signal gain is defined here as the ratio of the induced diode current to the incident beam current.

The epitaxial InSe layer is very uniform, thereby minimizing the media noise in the readback signal. At 2 keV, the standard deviation in the induced current in unwritten regions is typically less than 20% of the mean value.

Electron beams with energies of 2 keV or less have a Grun range (a measure of the penetration depth) of 25 nm or less in InSe. Therefore, they only generate carriers very near the surface of the InSe. Thus, the high signal gains measured at 2 keV and below show that epitaxial InSe layers allow for a collection efficiency of at least 6% even for carriers generated within 25 nm of the surface. This confirms that this vdW material has minimal problems with surface recombination, band-bending, and so forth.

These experiments were done with uncapped samples that have been exposed to air. The fact that high collection efficiencies are seen in unwritten regions with low energy (2 keV or less) read beams indicates that this material is relatively insensitive to surface problems caused by oxidation.

There are minimal problems with grain boundaries. This is verified by TEM measurements that show that the epitaxial layers are of high structural quality.

A large contrast in the diode signal is observed between the crystalline background and the amorphized spots (bits). At 2 keV, the induced current over the amorphized bits is less than 5% of the mean induced current over the unwritten regions. The minimum current measured in the unwritten regions is typically greater than 40% of the mean current (and the RMS deviation is typically less than 20%), so there is adequate signal contrast between the written and unwritten regions.

### EXAMPLE 2

Another embodiment structure 270 is shown in FIG. 11, as it pertains to diode storage media. Structure 270 involves growing a Schottky barrier junction 280 between a semiconductor data layer 272 and a metal layer 274. Either or both the semiconductor layer 272 or the metal layer 274 (or semi-metal, such as TiS₂) are two-dimensional materials. A buffer layer 276 is optional between the metal layer 274 and the substrate 278.

### Advantages of Two-dimensional Layers in Data Storage and Retrieval Devices

There are several advantages with respect to utilizing two-dimensional layers in the data storage and retrieval devices described above. With respect to the secondary emission devices described with respect to FIG. 1, epitaxial two-dimensional layers enhance the uniformity of the secondary/backscattering emissions.

For diode-type and transistor-type data storage and retrieval devices of the type described in FIGS. 2 and 3, the use of two-dimensional layers will lead to junctions with better material properties. These properties include (1) a reduction in the number of grain boundaries and/or a decrease in the number of problematic defects at grain boundaries in a two-dimensional semiconducting layer, which can lead to improved electrical properties for the junction, (2) better surfaces and interfaces such as abrupt, uniform surfaces and interfaces with few defects, (3) better spatial uniformity, or (4) fewer problematic defects within the semiconducting layers.

The use of two-dimensional materials and vdW epitaxy or quasi vdW epitaxy can also provide advantages for the cathconductivity or photoconductivity storage media described above with respect to FIG. 4. As with the diode and transistor storage media, these advantages stem from improvements to carrier lifetime, carrier mobility, media uniformity, and surface quality due to fewer dangling bonds, grain boundaries, misoriented grains, and mismatched interfaces. These factors can lead to improvements in the strength and uniformity of the cathodoconductivity or photoconductivity exhibited by the storage medium in one of its states, and improvements to the contrast in cathodoconductivity or photoconductivity provided by different states.

These factors can also lead to larger cathodoconductivity or photoconductivity signals when the material is stimulated by low-energy electrons or high energy photons that create carriers primarily near the surface of the device (e.g. by providing low surface recombination velocities). Again, there can be some advantage in using two-dimensional materials even in the absence of epitaxy because two-dimensional materials intrinsically tend to have fewer problems, such as with surface and interface recombination, trapping, and band-bending.

Two-dimensional materials and vdW epitaxy or quasi vdW epitaxy can also improve the operation of the cathodoluminescent or photoluminescent storage media described above with respect to FIG. 5. These storage media require strong contrast in the cathodoluminescence or photoluminescence between different states of the storage material. To achieve high areal storage densities, uniformity of the material properties on small length scales, for a given state, is also required. Two-dimensional materials, particularly those grown epitaxially, typically contain fewer defects that cause unwanted non-radiative recombination or radiative recombination at undesirable wavelengths. Epitaxial films also tend to be more uniform than non-epitaxial, polycrystalline films. Also, two-dimensional materials, with or without epitaxy, tend to have fewer problems with surface states and grain boundaries that contain defects that adversely impact the luminescence, than do non-2-D materials.

Finally, the use of two-dimensional materials and vdW epitaxy or quasi vdW epitaxy can improve the functioning of the storage medium described in above with respect to FIG. 6. As described in the previous paragraphs, the use of two-dimensional materials and vdW epitaxy or quasi vdW epitaxy can improve the luminescent properties and uniformity of the luminescent layer. Alternatively or in addition, a two-dimensional material with improved uniformity and contrast in its reflectivity and/or absorptivity can be used for the phase-change layer.

### Conclusion

As can be seen from the above discussion, the use of two-dimensional materials, particularly 2-D chalcogenide-based materials, provides a number of important advantages over prior materials used in data storage and retrieval devices. These advantages include (1) better interfaces, (2) better and/or fewer grain boundaries, (3) elimination or easing of doping requirements, by utilizing naturally p-type and naturally n-type layered chalcogenide materials, (4) improvement and ease in the doping process by eliminating compensating defects and grain boundaries. Other advantages include (5) better uniformity resulting in less media noise, (6) better ability to grow layers on a variety of substrates, including insulators and metals, (7) better surfaces and (8) overall better film quality, that is fewer defects, better electrical and optical properties.

The principles of the present invention can be applied with many other variations to the circuits, structures, arrangements and processes described herein, as will be apparent to those of ordinary skill in the art, without departing from the scope of the invention as defined in the appended claims.

What is claimed is:

1. An ultra-high density data storage and retrieval unit having a data layer for storing and/or retrieving data and having another layer, wherein the data layer and/or the other layer comprises a two-dimensional material.

2. The ultra-high density data storage and retrieval unit of claim 1, wherein the data layer is a phase-change layer capable of changing between a first stable state and a second stable state.

3. The ultra-high density data storage and retrieval unit of claim 1, wherein the two-dimensional material comprises a two-dimensional chalcogen-based material.

4. The ultra-high density data storage and retrieval unit of claim 3, wherein the two-dimensional chalcogen-based material is selected from a group consisting of the included class of two-dimensional chalcogen-based materials.

5. The ultra-high density data storage and retrieval unit of claim 3, wherein the chalcogen-based two-dimensional material is selected from a group consisting of The III-VI compounds InTe, InSe, GaSe, GaS and the hexagonal (metastable) form of GaTe.

6. The ultra-high density data storage and retrieval unit of claim 3, wherein The chalcogen-based two-dimensional material is selected from a group consisting of the IV-VI compounds GeS, GeSe, SnS, SnSe, SnS₂, SnSe₂, and SnSe₂₋ₓSₓ.

7. The ultra-high density data storage and retrieval unit of claim 3, wherein the chalcogen-based two-dimensional material is selected from a group consisting of the transition metal chalcogenides TiS₂, TiS₃, ZrS₂, ZrS₃, ZrSe₂, ZrSe₃, HfS₂, HfS₃, HfSe₂, and HfSe₃.

8. The ultra-high density data storage and retrieval unit of claim 3, wherein the chalcogen-based two-dimensional material is selected from a group consisting of the compounds Ga₂S₃, Ga₂Se₃, Ga₂Te₃, In₂Se₃, In₂Se₃, In₂Te₃, GeS₂, GeAs₂, and Fe₃S₄.

9. The ultra-high density data storage and retrieval unit of claim 3, wherein The chalcogen-based two-dimensional material is selected from a group consisting of the ternary two-dimensional materials.

10. The ultra-high density data storage and retrieval unit of claim 1, wherein the other layer comprises a substrate.

11. The ultra-high density data storage and retrieval unit of claim 1, wherein the other layer comprises a film.

12. The ultra-high density data storage and retrieval unit of claim 1, wherein the phase-change layer comprises a substrate.

13. The ultra-high density data storage and retrieval unit of claim 1, wherein the phase-change layer comprises a film.

14. The ultra-high density data storage and retrieval unit of claim 1, further comprising a data detection device, wherein the phase-change layer and/or the other layer comprises a two-dimensional member of the data detection device.

15. The ultra-high density data storage and retrieval unit of claim 14, wherein the two-dimensional member and/or members comprises a chalcogen-based material.

16. The ultra-high density data storage and retrieval unit of claim 14, wherein the data detection device is selected from a group consisting of photodiodes, cathododiodes, phototransistors, cathodotransistors, photoconductors, cathodoconductors, photoluminescent devices and cathodoluminescent devices.

17. The ultra-high density data storage and retrieval unit of claim 1, wherein at least one of the two-dimensional material layers has a single crystal structure formed by an epitaxial process.

18. The ultra-high density data storage and retrieval unit of claim 1, wherein at least one of the two-dimensional material layers has a polycrystalline structure.

19. An ultra-high density data storage and retrieval unit having multiple layers including a phase-change layer for storing and retrieving data, the data storage and retrieval unit having a structure selected from a group consisting of the following configurations:
2-D film/2-D substrate
2-D film/non-2-D substrate
non-2-D film/2-D substrate
2-D film/2-D film/X
2-D film/non-2-D film/X
non-2-D film/2-D film/X
wherein (1) the 2-D film is a two-dimensional material, (2) the 2-D film and the non-2-D film are a semiconductor, metal, or insulator, and (3) the term “X” is a substrate or film made of a material that is (a) 2-D or non-2-D and (b) metal, semiconductor or insulator.

20. The ultra-high density data storage and retrieval unit of claim 19, wherein at least one of the two-dimensional material layers is a chalcogen-based material.

21. The ultra-high density data storage and retrieval unit of claim 19, wherein at least one of the 2-D layers is selected from a group consisting of the included class of two-dimensional chalcogen-based materials.

22. The ultra-high density data storage and retrieval unit of claim 19 wherein the 2-D film comprises at least one layer of InSe.

23. The ultra-high density data storage and retrieval unit of claim 22, wherein the layer of InSe is formed on at least one layer of GaSe.

24. The ultra-high density data storage and retrieval unit of claim 23, wherein the layer of GaSe and/or the layer of InSe is a single crystal.

25. The ultra-high density data storage and retrieval unit of claim 23, wherein the layer of GaSe and/or the layer of InSe is polycrystalline.

26. The ultra-high density data storage and retrieval unit of claim 23, wherein the layer of GaSe is a film grown on a substrate.

27. The ultra-high density data storage and retrieval unit of claim 24, wherein the substrate is Si(111).

28. The ultra-high density data storage and retrieval unit of claim 19 wherein the 2-D film comprises at least one layer of a diode.

29. The ultra-high density data storage and retrieval unit of claim 19, wherein the 2-D film is part of a data detection device selected from a group consisting of photodiodes, cathododiodes, phototransistors, cathodotransistors, photoconductors, cathodoconductors, photoluminescent devices and cathodoluminescent devices.

30. The ultra-high density data storage and retrieval unit of claim 19 further comprising a Schottky barrier junction formed adjacent to the phase-change layer and between a semiconductor data layer and a metal layer, wherein either or both of the semiconductor layer and the metal layer are two-dimensional materials.

31. An ultra-high density data storage and retrieval device having multiple layers, wherein at least one layer of the multiple layers is a two-dimensional chalcogen-based material.

32. The ultra-high density data storage and retrieval device of claim 31, further comprising a second layer adjacent to the one layer, wherein the one layer and the second layer are coupled substantially by van der Waals forces.

33. An ultra-high density data storage and retrieval device comprising a film disposed on a substrate, wherein the film and/or the substrate is a two-dimensional material.

34. An ultra-high density data storage and retrieval device comprising a first film disposed on a substrate and a second film disposed on the first film, wherein at least one of the first film, the second film and/or the substrate is a two-dimensional material.

35. An ultra-high density data storage and retrieval device comprising a first film disposed on a substrate, a second film disposed on the first film, and a third film disposed on the second film, wherein at least one of the first film, the second film, the third film and/or the substrate is a two-dimensional chalcogen-based material.

36. A method for forming an ultra-high density data storage and retrieval device comprising forming a data layer for storing and/or retrieving data, forming another layer, wherein the data layer and/or the other layer comprises a two-dimensional material.

37. The method for forming an ultra-high density data storage and retrieval device of claim 36, wherein the data layer is grown on the other layer epitaxially to form a single crystal.

38. The method for forming an ultra-high density data storage and retrieval device of claim 36, wherein the data layer is grown on the other layer in polycrystalline form.

39. The method for forming an ultra-high density data storage and retrieval device of claim 36, wherein the other layer is grown on a substrate epitaxially as a single crystal.

40. The method for forming an ultra-high density data storage and retrieval device of claim 36, wherein the other layer is grown on a substrate in polycrystalline form.

41. The method for forming an ultra-high density data storage and retrieval device of claim 36, wherein the two-dimensional material is a chalcogen-based material.

42. The method for forming an ultra-high density data storage and retrieval device of claim 36, wherein the two-dimensional material is selected from a group consisting of the included class of two-dimensional chalcogen-based materials.

43. The method for forming an ultra-high density data storage and retrieval device of claim 36, wherein the two-dimensional material comprises at least one layer of InSe.

44. The method for forming an ultra-high density data storage and retrieval device of claim 43, wherein the layer of InSe is formed on at least one layer of GaSe.

45. The method for forming an ultra-high density data storage and retrieval device of claim 44, wherein the layer of GaSe and/or the layer of InSe is formed epitaxially as a single crystal.

46. The method for forming an ultra-high density data storage and retrieval device of claim 44, wherein the layer of GaSe and/or the layer of InSe are deposited in polycrystalline form.

47. The method for forming an ultra-high density data storage and retrieval device of claim 44, wherein the layer of GaSe is grown as a film on a substrate.

48. The method for forming an ultra-high density data storage and retrieval device of claim 44, wherein the layer of GaSe is grown as a film on Si(111).

49. The method for forming an ultra-high density data storage and retrieval device of claim 36, wherein the two dimensional material comprises at least one layer of a diode.

50. The method for forming an ultra-high density data storage and retrieval device of claim 36, wherein the two dimensional material comprises part of a data detection device selected from a group consisting of photodiodes, cathododiodes, phototransistors, cathodotransistors, photoconductors, cathodoconductors, photoluminescent devices and cathodoluminescent devices.
